(19) United States
(12) Patent Application Publication
(10) Pub. No.: US 2025/0317004 A1
(43) Pub. Date: Oct. 9, 2025

(54) WIRELESS CHARGING DEVICE

(71) Applicant: LITE-ON TECHNOLOGY CORPORATION, Taipei (TW)

(72) Inventors: Li-Yuan HSU, Taipei (TW); Chia-Yuan LI, Taipei (TW)

(21) Appl. No.: 18/906,186

(22) Filed: Oct. 4, 2024

Related U.S. Application Data
(60) Provisional application No. 63/631,481, filed on Apr. 9, 2024.

(30) Foreign Application Priority Data
Aug. 21, 2024 (TW) 113131438

(51) Int. Cl. H02J 50/00; B60L 53/122; B60L 53/124; B60L 53/30; H02J 50/10; H02J 50/60

(52) U.S. Cl. CPC H02J 50/005; H02J 50/10; H02J 50/60; B60L 53/122; B60L 53/124; B60L 53/30

(57) ABSTRACT

A wireless charging device includes a first cover, a second cover, a foreign object detection component and a coil carrier tray. The foreign object detection component is disposed between the first cover and the second cover and has a through hole. The coil carrier tray is disposed between the first cover and the second cover, and includes a protrusion, wherein the protrusion passes through the through hole and abuts against the first cover.

This application claims the benefit of U.S. provisional application Ser. No. 63/631,481, filed Apr. 9, 2024, the subject matter of which is incorporated herein by reference, and claims the benefit of Taiwan application Serial No. 113131438, filed on Aug. 21, 2024, the subject matter of which is incorporated herein by reference.

### BACKGROUND OF THE INVENTION

### Field of the Invention

The invention relates in general to a wireless charging device

### Description of the Related Art

Due to environmental protection, consumers' demand for electric vehicles is increasing day by day. Therefore, the electric vehicle market has also begun to have demand for wireless charging. When the electric vehicle is located above the wireless charging device, the wireless charging device may charge the electric vehicle. However, if the electric vehicle accidentally rolls over the wireless charging device, the wireless charging device may be easily damaged. Therefore, proposing a wireless charging device capable of improving the aforementioned problems is one of the goals of those in this technical field.

### SUMMARY OF THE INVENTION

According to an embodiment of the present invention, a wireless charging device is provided. The wireless charging device includes a first cover, a second cover, a foreign object detection component and a coil carrier tray. The foreign object detection component is disposed between the first cover and the second cover and has a through hole. The coil carrier tray is disposed between the first cover and the second cover and includes a protrusion, wherein the protrusion passes through the through hole and abuts against the first cover.

According to another embodiment of the present invention, a wireless charging device is provided. The wireless charging device includes a first cover, a second cover, a foreign object detection component, a coil carrier tray and an energy induction tray. The foreign object detection component is disposed between the first cover and the second cover. The coil carrier tray is disposed between the first cover and the second cover. The energy induction tray is disposed between the first cover and the second cover. The first cover abuts against the coil carrier tray, the coil carrier tray abuts against the energy induction tray, and the energy induction tray abuts against the second cover.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A illustrates a schematic diagram of a wireless charging device 100 according to an embodiment of the present invention;

FIG. 1B illustrates a schematic diagram of a top view of the wireless charging device 100 in FIG. 1A (not illustrated);

FIG. 2 illustrates a schematic diagram of the wireless charging device 100 in FIG. 1A disposed on a carrier 10;

FIGS. 3 and 4 illustrate schematic diagrams of exploded views (not illustrates the energy induction component 165) of the wireless charging device 100 in FIG. 1A from different angles;

FIG. 5A illustrates a schematic diagram of a cross-sectional view of the wireless charging device 100 in FIG. 1A along a direction 5A-5A′;

FIG. 5B illustrates a schematic diagram of a cross-sectional view of the wireless charging device 100 in FIG. 1A along a direction 5B-5B′;

FIG. 5C illustrates a schematic diagram of a cross-sectional view of the wireless charging device 100 in FIG. 1A along a direction 5C-5C′;

FIG. 6A illustrates a schematic diagram of a relationship between the safety factors of Table 1 and a plurality of the second fixing components 105B; and

FIG. 6B illustrates a schematic diagram of the safety factors of Table 2 and a plurality of the second fixing components 105B.

### DETAILED DESCRIPTION OF THE INVENTION

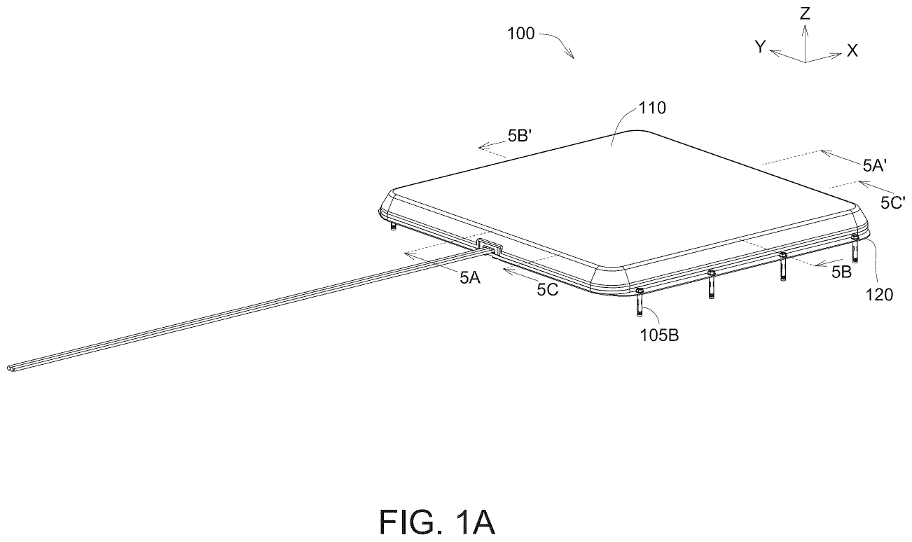

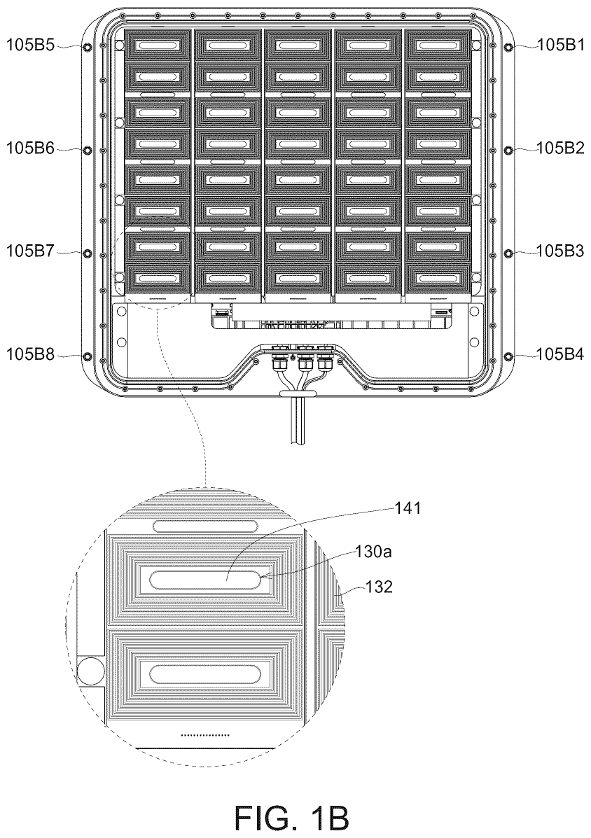

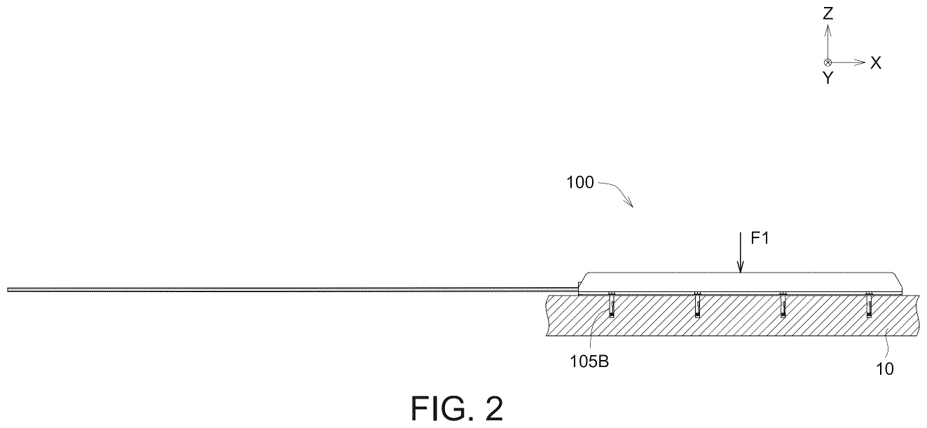

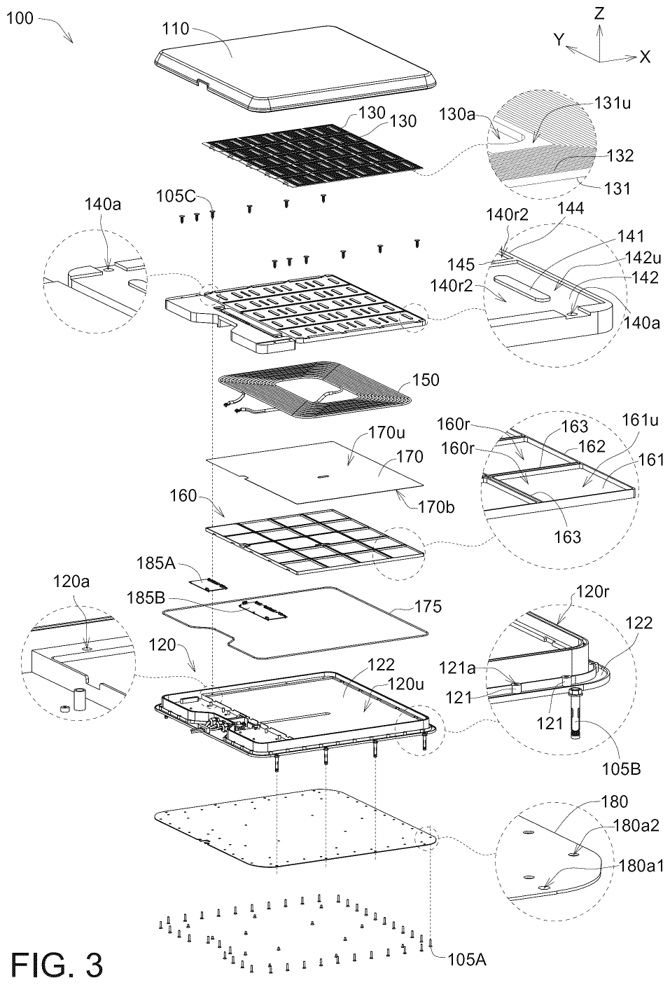

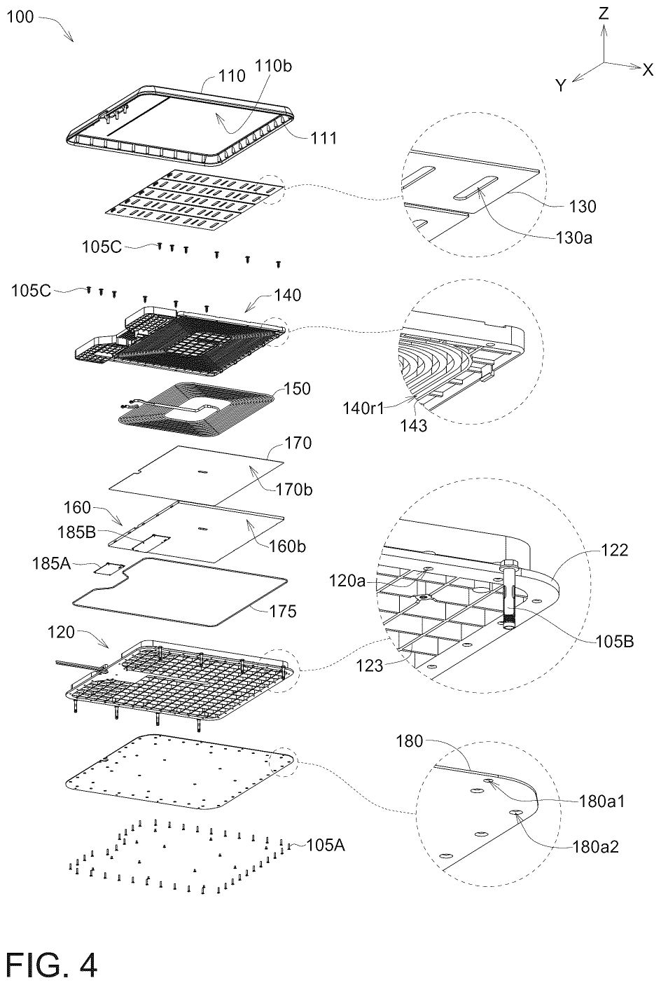

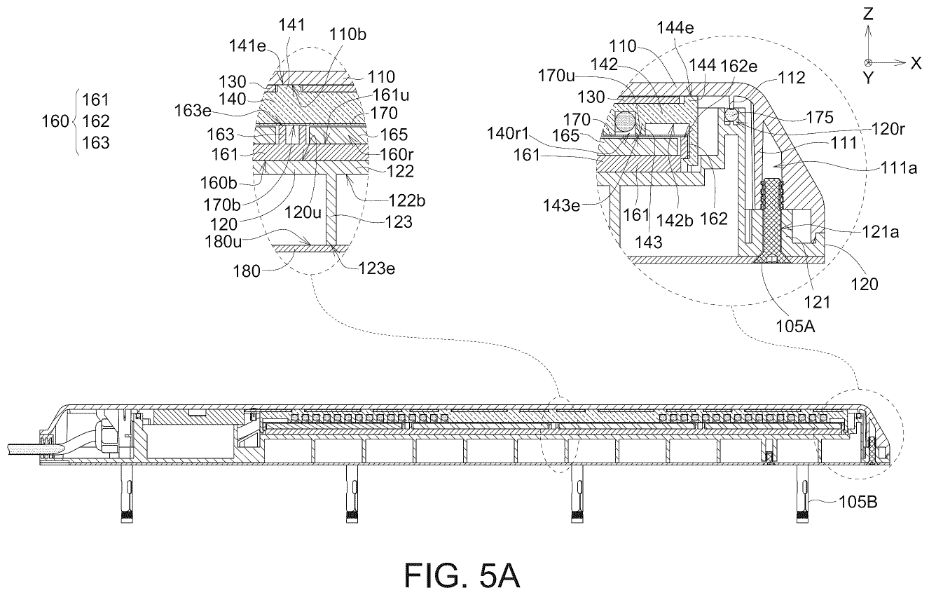

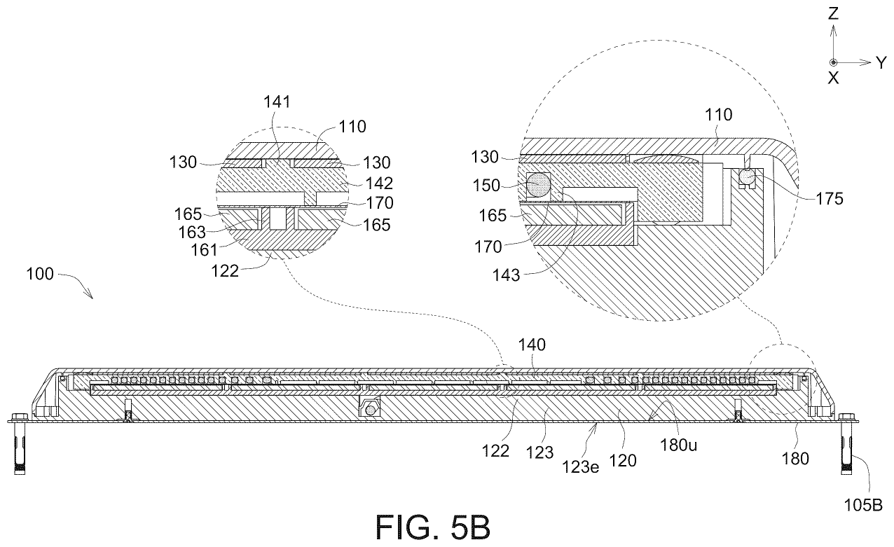

Referring to FIGS. 1A to 5C, FIG. 1A illustrates a schematic diagram of a wireless charging device 100 according to an embodiment of the present invention, FIG. 1B illustrates a schematic diagram of a top view of the wireless charging device 100 in FIG. 1A (not illustrated), FIG. 2 illustrates a schematic diagram of the wireless charging device 100 in FIG. 1A disposed on a carrier 10, FIGS. 3 and 4 illustrate schematic diagrams of exploded views (not illustrates the energy induction component 165) of the wireless charging device 100 in FIG. 1A from different angles, FIG. 5A illustrates a schematic diagram of a cross-sectional view of the wireless charging device 100 in FIG. 1A along a direction 5A-5A′, FIG. 5B illustrates a schematic diagram of a cross-sectional view of the wireless charging device 100 in FIG. 1A along a direction 5B-5B′, and FIG. 5C illustrates a schematic diagram of a cross-sectional view of the wireless charging device 100 in FIG. 1A along a direction 5C-5C′.

As illustrated in FIGS. 1A and 2, the wireless charging device 100 may be disposed on the carrier 10, and configured to charge the electronic device located on the wireless charging device 100. The carrier 10 is, for example, a ground, a floor, or any other carrier that may carry the wireless charging device 100. The electronic device is, for example, an electric vehicle with at least one wheel, such as an electric motorcycle, an electric car, an electric bicycle, etc.

As illustrated in FIGS. 1A to 4, the wireless charging device 100 includes at least a first fixing component 105A, at least a second fixing component 105B, at least a third fixing component 105C, a first cover (or a top cover) 110, a second cover (or a bottom case) 120, at least one foreign object detection (FOD) component 130, a coil carrier tray 140, a charging coil 150, an energy induction tray 160, at least one energy induction component 165, an insulation component 170, a sealing component 175, a pressing plate 180, a first circuit board 185A and a second circuit board 185B.

As illustrated in FIGS. 1A to 4, the foreign object detection component 130 is disposed between the first cover 110 and the second cover 120 and has at least one through hole 130a. The coil carrier tray 140 is disposed between the first cover 110 and the second cover 120 and includes at least one protrusion 141, wherein the protrusion 141 passes through the through hole 130a and abuts against the first cover 110. As a result, a force F1 (for example, a vehicle weight) exerted on the first cover 110 may be transferred to the carrier 10 through the coil carrier tray 140.

As illustrated in FIGS. 3, 4 and 5A, the first cover 110 and the coil carrier tray 140 may directly or indirectly abut against each other. In the present embodiment, the first cover 110 and the coil carrier tray 140 directly abut with each other. The term “directly abut” herein means that two components are directly connected without other component between them, while the term “indirectly contact” means that the two components are connected through other component. The first cover 110 has a lower surface 110b, and the protrusion 141 has an end surface 141e. The end surface 141e of the protrusion 141 abuts against the lower surface 110b of the first cover 110 to transfer the force F1. In an embodiment, the protrusion 141 is in surface contact with the first cover 110, which may reduce the pressure of the force F1 acting on the surface. In an embodiment, the end surface 141e of the protrusion 141 and the lower surface 110b of the first cover 110 are, for example, flat surfaces (planes). The first cover 110 includes at least one abutting post 111, and each abutting post 111 has a fixing hole 111a. The second cover 120 includes at least one abutting post 121, and each abutting post 121 has a through hole 121a. The first fixing component 105A may pass through the through hole 121a of the abutting post 121 and be fixed to the fixing hole 111a of the abutting post 111 of the first cover 110 to fix a relative position of the first cover 110 and the second cover 120. In an embodiment, the fixing hole 111a is, for example, a threaded hole, and the first fixing component 105A is, for example, a threaded component.

As illustrated in FIGS. 3, 4 and 5A, the second cover 120 includes a cover body 122 and an abutting portion 123. The cover body 122 has a lower surface 122b, and the abutting portion 123 is connected to the lower surface 122b and protrudes relative to the lower surface 122b. The pressing plate 180 and the second cover 120 may directly or indirectly abut against each other. In the present embodiment, the pressing plate 180 and the second cover 120 directly abut against each other. The abutting portion 123 has an end surface 123e, and the end surface 123e of the abutting portion 123 may abut against an upper surface 180u of the pressing plate 180.

As illustrated in FIGS. 1B, 3, 4 and 5A, the foreign object detection component 130 is disposed between the first cover 110 and the coil carrier tray 140. The foreign object detection component 130 includes a carrier plate 131 and at least one foreign object detection coil (FOD coil) 132. The carrier plate 131 has an upper surface 131u, and the foreign object detection coil 132 is disposed on the upper surface 131u of the carrier plate 131. The foreign object detection coil 132 is configured to detect whether there is a foreign object located above the wireless charging device 100. The carrier plate 131 has the aforementioned through hole 130a, and the foreign object detection coil 132 surrounds the through hole 130a and does not overlap with the through hole 130a (as illustrated in FIG. 1B), and thus it may prevent the protrusion 141 from interfering with the foreign object detection coil 132 after passing through the through hole 130a. In the present embodiment, the number of the foreign object detection components 130 is multiple, for example, five. However, the embodiment of the present invention is not limited to this.

As illustrated in FIGS. 3, 4 and 5A, the coil carrier tray 140 is disposed between the foreign object detection component 130 and the second cover 120. The coil carrier tray 140 includes a coil carrier plate 142 and an abutting portion 143. The coil carrier plate 142 has a lower surface 142b. The abutting portion 143 is disposed on the lower surface 142b and protrudes relative to the lower surface 142b. The abutting portion 143 surrounds at least one groove 140r1. The charging coil 150 may be disposed in the groove 140r1. In the present embodiment, the charging coil 150 is entirely located in the groove 140r1, and it may prevent the charging coil 150 from protruding relative to the end surface 143e of the abutment portion 143, thereby preventing the charging coil 150 from interfering with components below the charging coil 150 (for example, the insulation component 170). Due to the charging coil 150 being entirely located within the groove 160r, the force F1 may not be transferred to the charging coil 150, and it may avoid damaging the charging coil 150. In addition, the end surface 143e may directly or indirectly abut against the upper surface 170u of the insulation component 170.

As illustrated in FIGS. 3, 4, and 5A, the coil carrier tray 140 further includes at least one first abutting portion 144 and at least one second abutting portion 145. The coil carrier plate 142 has an upper surface 142u. The first abutting portion 144 may be disposed on the upper surface 142u and protrude relative to the upper surface 142u. For example, the first abutting portion 144 may be connected to an edge of the upper surface 142u. The second abutting portion 145 is connected to the first abutting portion 144. The first abutting portion 144 and at least one second abutting portion 145 separate at least one groove 140r2. The aforementioned protrusion 141 is located in the groove 140r2. In addition, the number of the grooves 140r2 and the number of the foreign object detection components 130 are equal. Each foreign object detection component 130 may be disposed in the corresponding groove 140r2. In the present embodiment, the foreign object detection component 130 may be entirely located in the groove 140r2. As a result, the force F1 is not transferred to the foreign object detection component 130, and it may avoid damaging to the foreign object detection component 130.

As illustrated in FIG. 5A, the first abutting portion 144 has an end surface 144e. The end surface 144e of the first abutting portion 144 may directly or indirectly abut against the lower surface 110b of the first cover 110. In the present embodiment, the end surface 144e directly abuts against the lower surface 110b. As illustrated in FIGS. 3 and 5C, the second abutting portion 145 has an end surface 145e. The end surface 145e of the second abutting portion 145 may directly or indirectly abut against the lower surface 110b of the first cover 110. In the present embodiment, the end surface 145e directly abut against the lower surface 110b.

As illustrated in FIGS. 3, 4 and 5A, the energy induction tray 160 is disposed between the first cover 110 and the second cover 120. The energy induction tray 160 and the coil carrier tray 140 may be engaged with each other. In addition, the energy induction tray 160 and the coil carrier tray 140 may directly or indirectly abut against each other. In the present embodiment, the energy induction tray 160 and the coil carrier tray 140 indirectly abut against each other. For example, the energy induction tray 160 abuts against the coil carrier tray 140 through the insulation component 170 to transmit the force F1. In another embodiment, the wireless charging device 100 may omit the insulation component 170. As a result, the energy induction tray 160 and the coil carrier tray 140 may directly abut against each other to transmit the force F1. In the present embodiment, the energy induction tray 160 is an object containing magnetically conductive material, such as a magnetically conductive disk.

As illustrated in FIGS. 3, 4, and 5A, the energy induction tray 160 includes an energy induction carrier plate 161, at least one third abutting portion 162, and at least one fourth abutting portion 163. The energy induction carrier plate 161 has an upper surface 161u. The third abutting portion 162 may be disposed on the upper surface 161u and protrude relative to the upper surface 161u. For example, the third abutting portion 162 may be connected to an edge of the upper surface 161u. The fourth abutting portion 163 may be disposed on the upper surface 161u and protrude relative to the upper surface 161u. The fourth abutting portion 163 is connected to the third abutting portion 162. The third abutting portion 162 and at least one fourth abutting portion 163 separate at least one groove 160r. Each energy induction component 165 may be disposed in the corresponding groove 160r. In the present embodiment, the energy induction component 165 may be entirely disposed in the corresponding groove 160r. As a result, the force F1 may not be transferred to the energy induction component 165, and it may avoid damaging the energy induction component 165. In the present embodiment, the energy induction component 165 is an object containing magnetically conductive material, such as a magnetically conductive sheet.

As illustrated in FIGS. 3, 4, and 5A, the third abutting portion 162 has an end surface 162e. The end surface 162e of the third abutting portion 162 may directly or indirectly abut against the lower surface 170b of the insulation component 170 to transmit the force F1. In addition, the third abutting portion 162 and the insulation component 170 are in surface contact, and it may reduce the pressure of the force F1 acting on the surface. In the present embodiment, the end surface 162e of the third abutting portion 162 is directly connected to the lower surface 170b of the insulation component 170. The fourth abutting portion 163 has an end surface 163e. The end surface 163e of the fourth abutting portion 163 may directly or indirectly abut against the lower surface 170b of the insulation component 170 to transmit the force F1. In addition, the fourth abutting portion 163 and the insulation component 170 are in surface contact, and it may reduce the pressure of the force F1 acting on the surface. In the present embodiment, the end surface 163e of the fourth abutting portion 163 directly abut against the lower surface 170b of the insulation component 170. In another embodiment, the wireless charging device 100 may omit the insulation component 170. As a result, the end surface 163e of the fourth abutting portion 163 of the energy induction tray 160 may directly abut against the end surface 143e of the abutting portion 143 of the coil carrier tray 140 to transmit the force F1.

As illustrated in FIGS. 3, 4 and 5A, the energy induction tray 160 and the second cover 120 may directly or indirectly abut against each other. In the present embodiment, the energy induction tray 160 and the second cover 120 directly abut against each other. The energy induction tray 160 has a lower surface 160b, and the aforementioned second cover 120 has an upper surface 120u. The upper surface 120u of the second cover 120 may directly or indirectly abut against the lower surface 160b of the energy induction tray 160 to transmit the force F1. In addition, the second cover 120 and the energy induction tray 160 are in surface contact, and it may reduce the pressure of the force F1 acting on the surface. In the present embodiment, the upper surface 120u of the second cover 120 and the lower surface 160b of the energy induction tray 160 directly abut against each other. In an embodiment, the lower surface 160b mates with upper surface 120u. For example, the lower surface 160b and the upper surface 120u are both flat surfaces, but they may also be matching curved surfaces.

As illustrated in FIGS. 5A to 5B, the energy induction component 165 is, for example, a magnetic core. The magnetic core is made of ferrite, for example. Ferrite is a ceramic material with iron oxide as its main component. Ferrite, for example, is magnetic and may be used to make permanent magnets, transformer cores and other related applications.

As illustrated in FIGS. 3, 4 and 5A, the insulation component 170 is disposed between the first cover 110 (or the charging coil 150) and the second cover 120 (or the energy induction tray 160). The insulation component 170 has an upper surface 170u and a lower surface 170b. In the present embodiment, the abutting portion 143 of the coil carrier tray 140 may abut against the upper surface 170u of the insulation component 170. The energy induction tray 160 may abut against the lower surface 170b of the insulation component 170. The insulation component 170 is made of rubber or plastic, for example. In an embodiment, the insulation component 170 is, for example, Mylar.

As illustrated in FIGS. 3, 4 and 5A, the sealing component may be disposed between the first cover 110 and the second cover 120 to seal space between the first cover 110 and the second cover 120, and it may prevent external impurities from invading the space between the first cover 110 and the second cover 120. The second cover 120 has a groove 120r, and the sealing component 175 may be disposed in the groove 120r of the second cover 120. The first cover 110 includes an abutting portion 112. When the first cover 110 and the second cover 120 are combined, the abutting portion 112 abuts against the sealing component 175. The seal 175 is, for example, rubber.

As illustrated in FIGS. 3, 4 and 5A, the pressing plate 180 may be disposed on the second cover 120. For example, the pressing plate 180 may be disposed on the abutting portion 123 of the second cover 120. The pressing plate 180 is made of metal, such as aluminum or its alloy. The pressing plate 180 has at least one first through hole 180a1 and at least one second through hole 180a2. The aforementioned first fixing component 105A may pass through the first through hole 180a1 and the through hole 121a of the abutting post 121 of the second cover 120, and be fixed to the fixing hole 111a of the first cover 110 to fix a relative position among the first cover 110, the second cover 110 and the pressing plate 180. The second fixing component 105B may pass through the second through hole 180a2 of the pressing plate 180 and be fixed on the carrier 10 to fix the relative position between the pressing plate 180 and the carrier 10. In the present embodiment, the second fixing component 105B is, for example, an expansion screw. The third fixing component 105C may pass through the through hole 140a of the coil carrier tray 140 and be fixed to the fixing hole 120a of the second cover 120 to fix the relative position between the coil carrier tray 140 and the second cover 120. In an embodiment, the third fixing component 105C is, for example, a threaded component, and the fixing hole 120a of the second cover 120 is, for example, a threaded hole.

As illustrated in FIGS. 3 and 4, the first circuit board 185A and the second circuit board 185B may be disposed on or fixed on the second cover 120. The aforementioned charging coil 150 and the foreign object detection coil 132 may be electrically connected to the first circuit board 185A and/or the second circuit board 185B to be controlled by the first circuit board 185A and/or the second circuit board 185B. It should be noted that in the present embodiment, the foreign object detection takes a foreign object made of metal as an example. Therefore, the foreign object detection component 130 is a metal foreign object detection component, and the foreign object detection coil 132 is a metal foreign object detection coil.

Referring to Table 1 below, Table 1 lists the dynamic simulation stress results of each second fixing component 105B when the electric vehicle rolls over the wireless charging device 100 along a X direction, and Table 2 lists the dynamic simulation stress results of each second fixing component 105B when the electric vehicle rolls over the wireless charging device 100 along a Y direction. The electric vehicle rolls over the wireless charging device 100 with the parameters in Table 3 (simulated by rolling with single wheel). The numbering of the second fixing component 105B is illustrated in FIG. 1B. The size of the second fixing component 105B is simulated as M8 (metric) and the strength level is 4.8. Its theoretical bearable maximum axial force is 10.5 kN (kilonewtons), and its theoretical bearable maximum shear force is 5.86 kN.

TABLE 1
(Dynamic simulation force results along the X direction)
Screw size: M8; Strength level: 4.8
Theoretically bearable maximum axial force Ft_{,Rd}: 10.5 kN;
Theoretically bearable maximum shear force FV_{,Rd}: 5.86 kN

| numbering of the second | | | | |
|---|---|---|---|---|
| fixing component 105B | 105B1 | 105B2 | 105B3 | 105B4 |
| bear maximum axial force | 219 | 202 | 201 | 302 |
| Ft_{,Ed} (N) | | | | |
| bear maximum shear force | 1150 | 958 | 906 | 1080 |
| FV_{,Ed} (N) | | | | |
| Comprehensive safety factor: | 0.211 | 0.177 | 0.168 | 0.205 |
| $\frac{( {Fv}_{, Ed} / {Fv}_{, Rd} ) + ( {Ft}_{, Ed} / {Ft}_{, Rd} )}{1.4}$ | | | | |
| numbering of the second | | | | |
| fixing component 105B | 105B5 | 105B6 | 105B7 | 105B8 |
| bear maximum axial force | 342 | 407 | 386 | 369 |
| Ft_{,Ed} (N) | | | | |
| bear maximum shear force | 1390 | 1380 | 1460 | 1250 |
| FV_{,Ed} (N) | | | | |
| Comprehensive safety factor: | 0.260 | 0.263 | 0.275 | 0.238 |
| $\frac{( {Fv}_{, Ed} / {Fv}_{, Rd} ) + ( {Ft}_{, Ed} / {Ft}_{, Rd} )}{1.4}$ | | | | |

TABLE 2
(Dynamic simulation force results along the Y direction)
Screw size: M8; Strength level: 4.8
Theoretically bearable maximum axial force Ft_{,Rd}: 10.5 kN ;
Theoretically bearable maximum shear force FV_{,Rd}: 5.86 kN

| numbering of the second fixing | | | | |
|---|---|---|---|---|
| component 105B | 105B1 | 105B2 | 105B3 | 105B4 |
| bear maximum axial force | 253 | 173 | 230 | 352 |
| Ft_{,Ed} (N) | | | | |
| bear maximum shear force | 1060 | 1520 | 1450 | 1030 |
| FV_{,Ed} (N) | | | | |
| Comprehensive safety factor: | 0.198 | 0.271 | 0.263 | 0.200 |
| $\frac{( {Fv}_{, Ed} / {Fv}_{, Rd} ) + ( {Ft}_{, Ed} / {Ft}_{, Rd} )}{1.4}$ | | | | |
| numbering of the second fixing | | | | |
| component 105B | 105B5 | 105B6 | 105B7 | 105B8 |
| bear maximum axial force | 262 | 146 | 221 | 428 |
| Ft_{,Ed} (N) | | | | |
| bear maximum shear force | 1050 | 1530 | 1400 | 1030 |
| FV_{,Ed} (N) | | | | |
| Comprehensive safety factor: | 0.197 | 0.271 | 0.254 | 0.205 |
| $\frac{( {Fv}_{, Ed} / {Fv}_{, Rd} ) + ( {Ft}_{, Ed} / {Ft}_{, Rd} )}{1.4}$ | | | | |

TABLE 3

| | |
|---|---|
| wheel weight (N) | 4893 |
| tire specification | P225/75R 15 |
| tire pressure (kpa) | 218 ± 13 |
| Rolling speed (km/h) | 8 ± 2 |

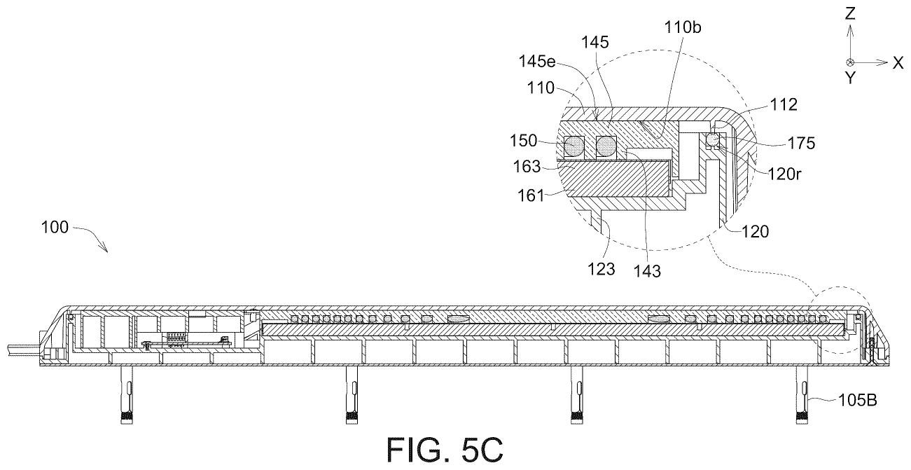

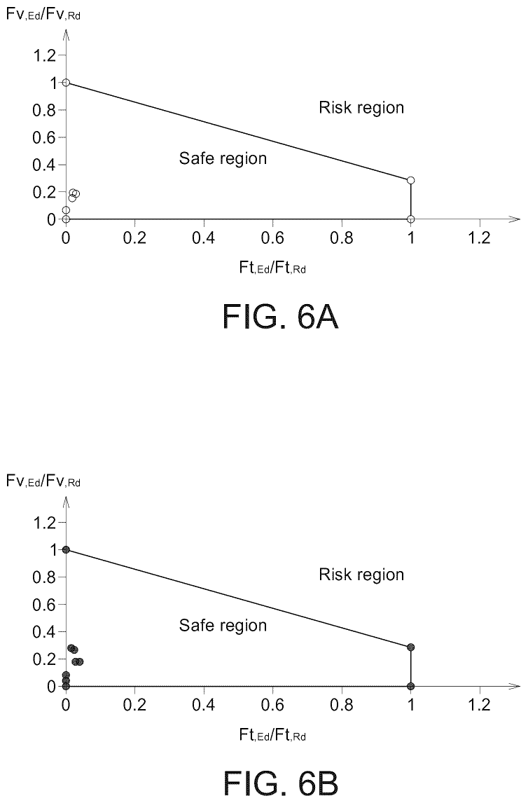

Referring to FIGS. 6A and 6B, FIG. 6A illustrates a schematic diagram of a relationship between the safety factors of Table 1 and a plurality of the second fixing components 105B, and FIG. 6B illustrates a schematic diagram of the safety factors of Table 2 and a plurality of the second fixing components 105B. The axis of abscissa in the figure represents the safety factor of the second fixing component 105B bearing the axial force, and the axis of ordinate represents the safety factor of the second fixing component 105B bearing the shear force. It may be seen from FIG. 6A that the safety factors of all the second fixing components 105B1 to 105B8 (shown as hollow circles in the figure) bearing the axial force and the safety factors of all the second fixing components 105B1 to 105B8 bearing the shear force are less than 1 (the further away from 1, the safer the second fixing component 105B is). It may be seen from FIG. 6B that the safety factors of all the second fixing components 105B1 to 105B8 (shown as filled circles in the figure) bearing the axial force and the safety factors of all the second fixing components 105B1 to 105B8 bearing the shear force are less than 1. This is sufficient to confirm that the force exerted by the electric vehicle is effectively and dispersedly transmitted to at least one component of the wireless charging device 100 for avoiding an excessive concentration of the force exerted by the electric vehicle on a certain component (for example, the second fixing member 105B).

According to the static simulation results, no matter which position of the first cover 110 of the wireless charging device 100 in FIG. 1 is applied statically (along Z direction) by a single wheel weight (applying force), the maximum stresses is borne by the wireless charging device 100 are all less than the maximum bearable stress of the first cover 110. If the material of the first cover 110 is polypropylene (PC), its maximum bearable stress is approximately 62 MPa. The maximum stress statically exerted (along the Z direction) on any position of the first cover 110 of the wireless charging device 100 in FIG. 1 by the single wheel weight in Table 3 does not exceed 20 MPa, and this is sufficient to confirm that the force exerted by the electric vehicle is effectively and dispersedly transmitted to at least one component of the wireless charging device 100 for avoiding an excessive concentration of the force exerted by the electric vehicle on a certain component (for example, the second fixing member 105B).

In summary, the embodiment of the present invention provides a wireless charging device. The wireless charging device includes a first cover, a second cover, a coil carrier tray and an energy induction tray. When a force acts on the first cover, the force may be transferred to the second cover through the first cover and the coil carrier tray, and/or transferred to the second cover through the first cover, the coil carrier tray and the energy induction tray. The wireless charging device further includes a component (for example, a coil, a foreign object detection component and/or an energy induction component, etc.), and such component may be disposed between two of the first cover, the second cover, the coil carrier tray and the energy induction tray, and is not subject to a force (not abutted or not clamped) by the first cover, the second cover, the coil carrier tray and/or the energy induction tray. When a force is applied to the first cover, the force is not transferred to such component. In addition, the two abutting components may be in line abutment or surface abutment. Compared with the point-contact, the line-contact or the surface-contact may reduce the pressure exerted on the line or the surface, thereby reducing the stress on the force-bearing component.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A wireless charging device, comprising:
a first cover;
a second cover;
a foreign object detection component disposed between the first cover and the second cover and having a through hole; and
a coil carrier tray disposed between the first cover and the second cover and comprising a protrusion, wherein the protrusion passes through the through hole and abuts against the first cover.

2. The wireless charging device according to claim 1, wherein the first cover has a lower surface, and the protrusion abuts against the lower surface of the first cover.

3. The wireless charging device according to claim 2, wherein the lower surface of the first cover is a flat surface.

4. The wireless charging device according to claim 1, further comprising:
an energy induction tray abutting against the coil carrier tray.

5. The wireless charging device according to claim 4, wherein the energy induction tray comprises:
an energy induction carrier plate having an upper surface; and
an abutting portion disposed on the upper surface of the energy induction carrier plate and protruding relative to the upper surface of the energy induction carrier plate, wherein the abutting portion surrounds a groove, wherein the abutting portion abuts against the coil carrier tray;
wherein the wireless charging device further comprises:
an energy induction component disposed in the groove.

6. The wireless charging device according to claim 5, further comprising:
an insulation component;
wherein the abutting portion of the energy induction tray abuts against the insulation component.

7. The wireless charging device according to claim 1, wherein the coil carrier tray comprises:
a coil carrier plate having a lower surface; and
an abutting portion disposed on the lower surface of the coil carrier plate, protruding relative to the lower surface, and surrounding a groove;
wherein the wireless charging device further comprises:
a charging coil disposed in the groove.

8. The wireless charging device according to claim 7, further comprising:
an insulation component;
wherein the abutting portion of the coil carrier plate abuts against the insulation component.

9. The wireless charging device according to claim 4, wherein the second cover has an upper surface, the energy induction tray has a lower surface, and the upper surface of the second cover abuts against the lower surface of the energy induction tray.

10. The wireless charging device according to claim 1, further comprising:
a pressing plate abutting against the second cover.

11. The wireless charging device according to claim 1, wherein the foreign object detection component comprises:
a circuit board; and
a foreign object detection coil disposed on the circuit board and surrounding the through hole.

12. A wireless charging device, comprising:
a first cover;
a second cover;
a foreign object detection component disposed between the first cover and the second cover;
a coil carrier tray disposed between the first cover and the second cover; and
an energy induction tray disposed between the first cover and the second cover;
wherein the first cover abuts against the coil carrier tray, the coil carrier tray abuts against the energy induction tray, and the energy induction tray abuts against the second cover.

13. The wireless charging device according to claim 12, wherein the coil carrier tray is disposed between the first cover and the energy induction tray.

14. The wireless charging device according to claim 12, wherein the energy induction tray is disposed between the coil carrier tray and the second cover.

15. The wireless charging device according to claim 12, wherein the first cover has a lower surface, and the protrusion abuts against the lower surface of the first cover.

16. The wireless charging device according to claim 15, wherein the lower surface of the first cover is a flat surface.

17. The wireless charging device according to claim 12, wherein the energy induction tray comprises:
an energy induction carrier plate having an upper surface;
an abutting portion disposed on the upper surface, protruding relative to the upper surface, and surrounding a groove, wherein the abutting portion abuts against the coil carrier tray;
wherein the wireless charging device further comprises:
an energy induction component disposed in the groove.

18. The wireless charging device according to claim 17, further comprising:
an insulation component;
wherein the abutting portion of the energy induction tray abuts against the insulation component.

19. The wireless charging device according to claim 12, wherein the coil carrier tray comprises:
a coil carrier plate having a lower surface; and
an abutting portion disposed on the lower surface of the coil carrier plate, protruding relative to the lower surface, and surrounding a groove;
wherein the wireless charging device further comprises:
a charging coil disposed in the groove.

20. The wireless charging device according to claim 12, wherein the foreign object detection component comprises:
a circuit board; and
a foreign object detection coil disposed on the circuit board and surrounding a through hole of the foreign object detection component.
